(19) United States
(12) Patent Application Publication
(10) Pub. No.: US 2024/0430990 A1
(43) Pub. Date: Dec. 26, 2024

(54) Interior Surface Arrangement

(71) Applicant: Bayerische Motoren Werke Akiengesellschaft, Muenchen (DE)

(72) Inventors: Alfons BRUNNER, Dornwang (DE); Philipp HOFMANN, Wiedenzhausen (DE); Joachim MELZIG, Landshut (DE); Christof SCHOENHAMMER, Laberweinting (DE)

(21) Appl. No.: 18/705,724

(22) PCT Filed: Nov. 7, 2022
(86) PCT No.: PCT/EP2022/080903

§ 371 Date: Apr. 29, 2024

(30) Foreign Application Priority Data
Nov. 16, 2021 (DE) 10 2021 129 871.7

(51) Int. Cl. H05B 3/34; B32B 5/02; B32B 5/18; B32B 5/24; B32B 5/26

(52) U.S. Cl. CPC H05B 3/345; B32B 5/022; B32B 5/026; B32B 5/18; B32B 5/245; B32B 5/26; B32B 5/265; B32B 2260/021; B32B 2260/046; B32B 2451/00; B32B 2605/003

(57) ABSTRACT

An interior surface arrangement, preferably for motor vehicles, has a decorative structure including an outer cover layer, a surface heating element and a carrier layer. The surface heating element is integrated, preferably laminated, in the decorative structure adjacent to the outer cover layer.

### BACKGROUND AND SUMMARY

The invention relates to an interior surface arrangement according to the preamble of the independent claim.

In the generic interior surface arrangement, a planar heating element is either integrated into a carrier part or is only loosely inserted into a decorative substructure and covered by decorative material.

The disadvantage of this arrangement is, first of all, a high technical complexity for the integration of the planar heating element into the original mold or the original molding process (injection molding, pressing), with the removal of cables or connectors from the tool being particularly complex.

There is also disadvantageously strong deformation of the plastic assembly in the heated state owing to different thermal expansions of the individual components. This is due to heat input only into the heated carrier part and poor heat conduction into adjoining components, which results in a type of “bimetallic effect.”

It is also disadvantageous that high heating outputs are required to heat the decorative surface in a short time, since the carrier part and the decorative material have to be heated or absorb heat.

There is also poor controllability of the surface temperature, since the considerable thermal mass of the carrier part stores heat for a long time.

Known interior surface arrangements are disclosed in DE 20 2013 005 923 U and DE 10 2012 004 136 A1.

It is therefore an object of the present disclosure to provide an interior surface arrangement of the type specified in the preamble of the independent claim, which makes a lower thermal deformation of a carrier part during operation possible.

This object may be achieved by the features of the independent claim.

Specifically, the interior surface arrangement according to the disclosure, which is suitable in particular for motor vehicles, comprises a decorative structure having at least one outer decorative layer and a planar heating element. In this case, the disclosure provides for the planar heating element to be laminated or integrated into the decorative structure, preferably directly adjacent to the decorative layer. The layers of the interior surface arrangement are each adhesively bonded to one another.

As a result, in addition to a lower thermal deformation of the carrier part during operation compared with the prior art, the decorative surface is heated more rapidly with lower heating output. There is also advantageously a more sensitive controllability of the surface temperature.

The dependent claims provide advantageous embodiments of the invention.

In a particularly preferred embodiment, the planar heating element is arranged directly adjacent to the decorative layer, meaning that, in this embodiment, the planar heating element can rest directly on the decorative layer.

In a further preferred embodiment, it is possible for a haptic layer to be arranged between the planar heating element and the carrier layer. This affords the advantage of thermal insulation of the carrier part due to the provision of the haptic component.

It is also possible for a further haptic layer to be arranged between the decorative layer and the planar heating element.

The haptic layer may be in the form of a foam layer, in particular in the form of a cut foam, in the form of a knitted spacer fabric, or in the form of a nonwoven or a similar material.

The carrier layer preferably comprises a polymeric material.

Further details, features and advantages of the invention will emerge from the following description and from the figures.

### BRIEF DESCRIPTION OF THE DRAWINGS

In the figures:

FIG. 1 shows a schematically greatly simplified basic illustration of a first embodiment of an interior surface arrangement, and

FIG. 2 shows an illustration, corresponding to FIG. 1, of a second embodiment of the interior surface arrangement.

### DETAILED DESCRIPTION OF THE DRAWINGS

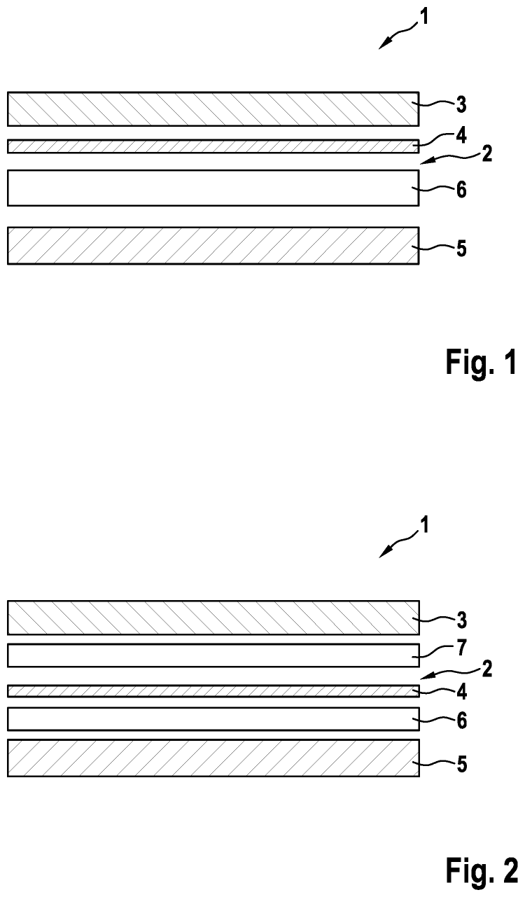

FIG. 1 illustrates a first embodiment of an interior surface arrangement 1 according to the disclosure, which is suitable in particular for use in motor vehicles.

In the embodiment illustrated in FIG. 1, the interior surface arrangement 1 comprises a decorative structure 2 which, in this embodiment, has an outer decorative layer 3, which is the layer of the interior surface arrangement 1 that is visible when installed, for example in a motor vehicle.

In this embodiment, a planar heating element 4 is arranged directly adjacent to the decorative layer 3 and can be connected thereto by way of an adhesive bond.

On its opposite side, the planar heating element 4 is also connected, for example likewise by way of an adhesive bond, to a haptic layer 6 arranged between the planar heating element 4 and the carrier part 5. The haptic layer 6 can also be connected to the carrier part 5, which preferably comprises a polymer, by way of an adhesive bond.

In the embodiment according to FIG. 2, in addition to the haptic layer 6, a second haptic layer 7 is arranged between the planar heating element 4 and the outer decorative layer 3 and can also be adhesively bonded to the decorative layer 3 and to the planar heating element 4. This affords the advantage that the heating wires of the planar heating element 4 can be leveled out.

However, in addition to an adhesive bond, other connecting devices are also conceivable.

In addition to the foregoing written disclosure of the invention, reference is hereby explicitly made, in order to supplement the disclosure, to the graphic illustration of embodiments of the invention in FIGS. 1 and 2.

### LIST OF REFERENCE SIGNS

1 Interior surface arrangement
2 Decorative structure
3 Outer cover layer
4 Planar heating element
5 Carrier layer
6 First haptic layer
7 Second haptic layer

1-9. (canceled)

10. An interior surface arrangement for a motor vehicle, the interior surface arrangement comprising:
a decorative structure including:
an outer decorative layer,
a planar heating element, and
a carrier layer,
wherein
the planar heating element is laminated into the decorative structure adjacent to the outer decorative layer, and
the outer decorative layer, the planar heating element and the carrier layer are each adhesively bonded.

11. The interior surface arrangement according to claim 10, wherein
the planar heating element directly adjoins the outer decorative layer.

12. The interior surface arrangement according to claim 10, further comprising at least one haptic layer directly adjoining the planar heating element.

13. The interior surface arrangement according to claim 12, wherein
the at least one haptic layer comprises a first haptic layer arranged between the planar heating element and the carrier layer.

14. The interior surface arrangement according to claim 13, wherein
the at least one haptic layer comprises a further haptic layer arranged between the outer decorative layer and the planar heating element.

15. The interior surface arrangement according to claim 12, wherein
the at least one haptic layer has the form of a foam layer.

16. The interior surface arrangement according to claim 15, wherein
the foam layer has the form of a cut foam layer.

17. The interior surface arrangement according to claim 12, wherein
the at least one haptic layer has the form of a knitted spacer fabric.

18. The interior surface arrangement according to claim 12, wherein
the at least one haptic layer has the form of a nonwoven.

19. The interior surface arrangement according to claim 10, wherein the carrier layer comprises a fiber-reinforced polymer.
